(19) United States
(12) Patent Application Publication
(10) Pub. No.: US 2004/0124404 A1
(43) Pub. Date: Jul. 1, 2004

(54) Rolling jack

(76) Inventor: Lowell D. Goldie, Naples, FL (US)

Correspondence Address: EDWARD M. LIVINGSTON, ESQUIRE, 963 TRAIL TERRACE DRIVE, NAPLES, FL, 34103, US

(21) Appl. No.: 10/335,003

(22) Filed: Dec. 30, 2002

(51) Int. Cl. B66F 7/22

(52) U.S. Cl. 254/94

(57) ABSTRACT

A rolling jack (10) for lifting, moving and holding vehicles (54) for transport repair and maintenance having two lateral side tubular members (12a,b) each with straight and arcuate sections, the side members being spaced apart and connected to each other by cross-members, a first cross-member (22) connecting the arcuate section and a second cross-member (34) to the straight section of the side members. The first cross member has a pin portion (44) for engaging an axle or other component of a vehicle. The second cross member has a sleeve (36) for inserting a leverage handle (42) for grasping by hands during the use of the rolling jack. An axle (58) having wheels (40a,b) on each end is affixed to a curved portion of the arcuate section of the side of the lateral side members on which the vehicle is supported when the rolling jack is used to move a vehicle as desired.

### CROSS-REFERENCE TO RELATED APPLICATION

This is application claims the benefit of U.S. Provisional Application No. ______, filed Jan. 2, 2002.

### BACKGROUND OF THE INVENTION

This invention is relates to devices used to facilitate the repair and maintenance of light vehicles, and more particularly a device that lifts the front or rear end of a light vehicle, such as a golf cart, in order to reposition said vehicle for repair and maintenance and to support said vehicle at an appropriate height in a stationary position to provide access for repair and maintenance.

Light vehicles such as golf carts, commercial lawnmowers, and the like require frequent and regular maintenance to ensure proper operation thereof and the completion of repairs to fix damaged or inoperable components. Depending upon the nature of the task, the vehicle must be lifted above a support or ground surface at either the front or rear end thereof in order to gain access to the under side of the vehicle. However, such vehicles are typically cumbersome and too heavy to be lifted by maintenance and repair personnel and thus require a mechanical means or other device to perform the lifting.

A common mechanical device for lifting vehicles is a hydraulic lift, whereby a vehicle is completely lifted above the support or ground surface. However, light vehicles are typically repaired and serviced in the garage or maintenance and repair shop of a lawn or landscaping business or golf course, and such garages or repair shops typically are not equipped with a hydraulic lift. Nevertheless, it is not necessary to lift a light vehicle completely above the support or ground surface as most repairs and maintenance tasks can be performed by only lifting either the front or rear end of the vehicle. Conventional jacks, which can be employed for such a purpose are time consuming, requiring the blocking of wheels and continual pumping with a leverage handle. Such jacks can present a safety hazard if not properly positioned and attached to the vehicle.

Furthermore, light vehicles that are inoperable must be moved to a work area, a task that typically involves manually pushing or pulling the vehicle, which may not be possible if the vehicle is too heavy for a worker to wheel about or if one or both of the wheels at one end of the vehicle is unable to rotate due to a mechanical problem.

What is needed then to overcome the aforementioned disadvantages of conventional light vehicle lifting devices is a rolling or movable jack that permits a user to quickly and easily lift a light vehicle at one end thereof in order to move or reposition said light vehicle to a work area and to maintain such vehicle at the work area in a raised, stationary position for repair and maintenance.

Numerous designs for rolling jacks and similar devices have been provided in the prior art. Even though these designs may be suitable for the specific individual purposes to which they address, they would not be suitable for the purposes of the present version of the invention. Such designs are exemplified by U.S. Pat. No. 5,228,651, issued to Warner on Jul. 20, 1993; and U.S. Pat. No. 5,716,061, issued to Sloan et al. on Feb. 10, 1998. Further, U.S. Pat. No. 5,826,857, issued to Brack et al. on Oct. 27, 1998 discloses a vehicle service stand designed to engage the front or rear lifting bar of a light vehicle, a component that may not be present in all such vehicles.

As such, it may be appreciated that there is a continuing need for a new and improved rolling jack for light vehicles that is simplified in design and construction and adaptable for use with a variety of light vehicles by engaging and lifting the axle or similar component of such vehicles. In these respects, the present version of the invention substantially departs from the conventional concepts and designs of the prior art, and in so doing provides an apparatus that substantially fulfills this need. Additionally, the prior patents and commercial techniques do not suggest the present inventive combination of component elements arranged and configured as disclosed herein.

The present invention achieves its intended purposes, objects, and advantages through a new, useful and unobvious combination of method steps and component elements, with the use of a minimum number of functioning parts, at a reasonable cost to manufacture, and by employing only readily available materials.

### SUMMARY OF THE INVENTION

The primary object of the present invention to provide a low-cost, easy-to-manufacture, and easy-to-market rolling jack for light vehicles.

A further object of my version of the invention is to provide an easy-to-use and versatile rolling jack for light vehicles.

An even further object of the invention is to provide a rolling jack that can be used to lift a light vehicle at either a front or rear end thereof in order to move said light vehicle or to maintain said light vehicle above a ground or support surface at a stationary position to provide access to the under side of said vehicle for servicing and to lower said vehicle when servicing is completed.

The present invention fulfills the above and other objects by providing a rolling jack for light vehicles that is comprised of two lateral side tubular members, said tubular members each having a straight section and an arcuate section with the straight section making contact with a support or ground surface when the rolling jack is in a resting position. The lateral side tubular members are maintained in parallel arrangement at some distance from each other by a first tubular cross member and a second tubular cross member.

The first tubular cross member is affixed at opposing ends thereof to unattached ends of the arcuate sections of the lateral side tubular members. Cylindrical caps are attached to the junction of the first tubular cross member and arcuate sections of the lateral side members, and a pin is affixed in rotating engagement to a medial portion of the first tubular cross member.

The second tubular cross member is attached at opposing ends to the straight sections of the lateral side tubular members, and a sleeve is attached in perpendicular arrangement to the medial portion of said second tubular cross member. The sleeve contains a bore and a notch at one end thereof and receives within said bore an elongate rod or leverage handle. A grasping handle is located at a first end of the leverage handle and a pin at a second end thereof.

An axle with wheels located at opposing ends thereof is attached to an outside of a bend of the arcuate sections of the lateral side tubular members. The wheels are disposed at some distance above a support or ground surface when the rolling jack is in a resting or unused position and so that said wheels make contact with the support or ground surface when said jack is pivoted to engage a light vehicle.

When the leverage handle is rotated within the sleeve the pin thereof occupies the notch of the sleeve, thereby locking the leverage handle within the sleeve. Once locked in place, the leverage handle can be used to pull, push, or pivot the rolling jack to move, lift, or lower a light vehicle. A user manipulates the grasping handle of the leverage handle to position the rolling jack under a light vehicle, at which point the pin, located on the first tubular cross member, engages an axle or similar component of the light vehicle. The leverage handle is then pushed downward so that the jack, pivoting upon the wheels lifts the light vehicle. At this point, the light vehicle can be wheeled, if necessary, to a work location. Otherwise, the leverage handle is pushed downward until it makes contact with the support or ground surface, and the rolling jack is disposed in a stationary position with the light vehicle securely supported above the support or ground surface.

The primary object of the present invention to provide a low-cost, easy-to-manufacture, and easy-to-market rolling jack for light vehicles.

A further object of my version of the invention is to provide an easy-to-use and versatile rolling jack for light vehicles.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

The foregoing and other objects, features and advantages of the invention will become more fully understood from the following description of the preferred embodiment of the invention as illustrated in the accompanying drawings in which like reference characters refer to the same parts throughout different views. The drawings are not necessarily to scale, emphasis instead being placed upon illustrating the principles of the invention.

FIG. 1 is a perspective view of a rolling jack for light vehicles of the present invention;

FIG. 2 is a detailed perspective view of the sleeve of the rolling jack for light vehicles of the present invention;

FIG. 3 is a perspective view of the rolling jack for light vehicles of the present invention with a leverage handle inserted therein;

FIG. 4 is a detailed perspective view of the sleeve of the rolling jack for light vehicles with the leverage handle inserted therein;

FIG. 5 is a perspective view of the rolling jack for light vehicles of the present invention with the leverage handle locked therein;

FIG. 6 is a detailed perspective view of the sleeve of the rolling jack for light vehicles with the leverage handle locked therein;

FIG. 7 is an elevation view of the rolling jack positioned under a light vehicle;

FIG. 8 is an elevation view of the rolling jack secured to a light vehicle and tilted back to raise the light vehicle above the ground surface, said jack resting upon wheels to allow movement of said vehicle;

FIG. 9 is an elevation view of the rolling jack secured to a light vehicle and tilted completely back, said roller jack resting upon the ground or surface support with said light vehicle supported above the ground or support surface in a stationary position; and

FIG. 10 is an elevation view of the light vehicle supported above the ground or support surface in a stationary position by jack stands, which were inserted under said light vehicle while said vehicle was supported by the rolling jack in order to free up the rolling jack.

### DESCRIPTION OF THE PREFERRED EMBODIMENTS

For purposes of describing the preferred embodiment, the terminology used in reference to the numbered components in the drawings is as follows:

| | |
|---|---|
| 10. | Roller Jack For Light |
| | Vehicles |
| 12a, b. | Tubular Member |
| 14a, b. | First End |
| 16a, b. | Second End |
| 18a, b. | Straight Section |
| 20a, b. | Arcuate Section |
| 22. | First Cross Member |
| 24a, b. | Cap |
| 26. | Pin Portion |
| 28. | Disc |
| 30. | Cylindrical Member |
| 32. | Cylindrical Member |
| 34. | Second Cross Member |
| 36. | Sleeve |
| 38. | Axle |
| 40a, b. | Wheel |
| 42. | Leverage Handle |
| 44. | Pin |
| 46. | Grasping Handle |
| 48. | Bore |
| 50. | Notch |
| 52. | Notch |
| 54. | Vehicle |
| 56. | Ground Surface |
| 58. | Axle |
| 60. | Jack Stand |

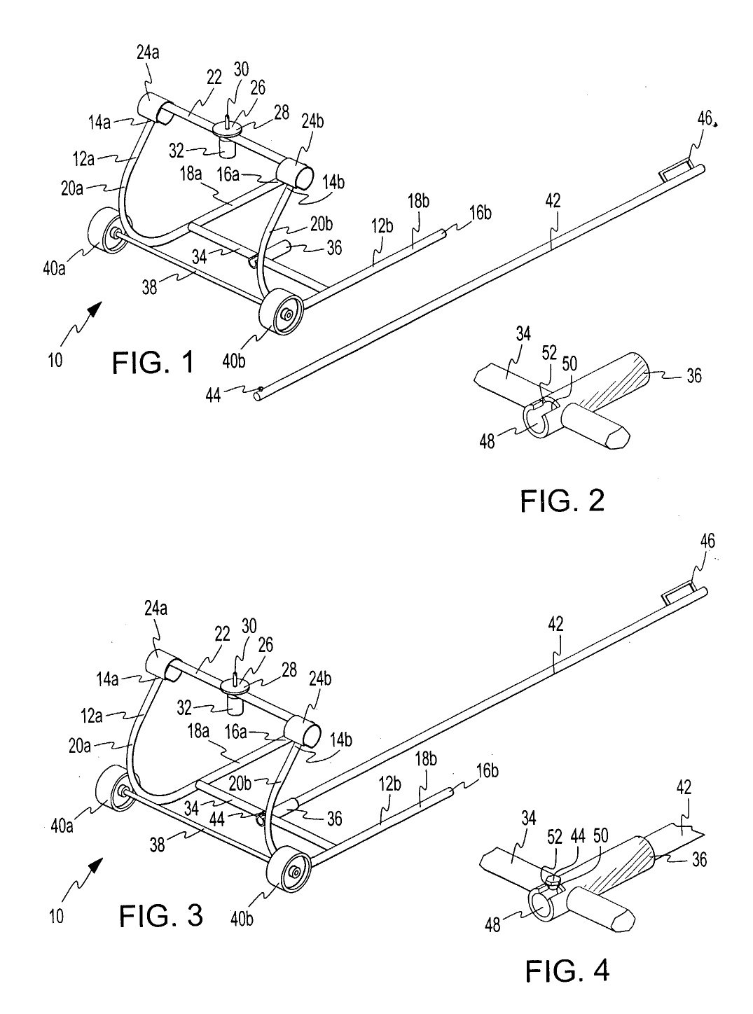

Referring now to the drawings and, in particular, to FIG. 1 wherein there is illustrated a typical embodiment of the roller jack for light vehicles 10 displayed in a resting or initial position. The present version of the invention 10 consists of two lateral side tubular members 12a, b that are disposed in parallel relation at some distance from each other. Each tubular member 12a, b is defined by a first end 14a, b and a second end 16a, b between which a straight section 18a, b and arcuate section 20a, b of the tubular members 12a, b are located. A first tubular cross member 22 is attached in perpendicular relation to the free ends of the arcuate sections 20a, b of the lateral side tubular members 12a, b. Cylindrical caps 24 cover the junction of the tubular cross member 22 with the arcuate sections 20a, b. A pin portion 26 is medially attached in rotating engagement to the tubular cross member 22. The pin 26 is comprised of a disc 28, which is affixed to the top side of the cross member 22, a first cylindrical member 30 attached in perpendicular arrangement to the disc 28, and a second cylindrical member 32 secured to the underside of said cross member 22.

A second tubular cross member 34 is attached in perpendicular relation at opposing ends thereof to the straight sections 18a, b of the lateral side tubular members 12a, b. A sleeve 36 is located at the medial portion of the second cross member 34 and is disposed perpendicularly to the longitudinal axis of said cross member 34. An axle 38 with wheels 40a, b located at opposing ends thereof is affixed to the outside curve of the arcuate sections 20a, b of the lateral side tubular members 12a, b. At the initial position of the jack 10 as illustrated, the wheels 40a, b are maintained approximately ¾ inch above a ground or support surface.

The roller jack 10 is moved and pivoted upon the wheels 40a, b by an elongate leverage handle 42 having a first end at which a pin 44 is located and a second end to which a grasping handle 46 is attached. The leverage handle 42 is inserted into the sleeve 36 50 that the first end with the pin 44 is disposed within the sleeve 36 and the second end with the grasping handle 46 is maintained in distal relation in order to provide maximum leverage and lifting action

Referring to FIG. 2, therein illustrated is in detail view the sleeve 36, which encloses a central bore 48 and is configured at one end thereof with an L-shaped cut having a first notch 50 and a second notch 52.

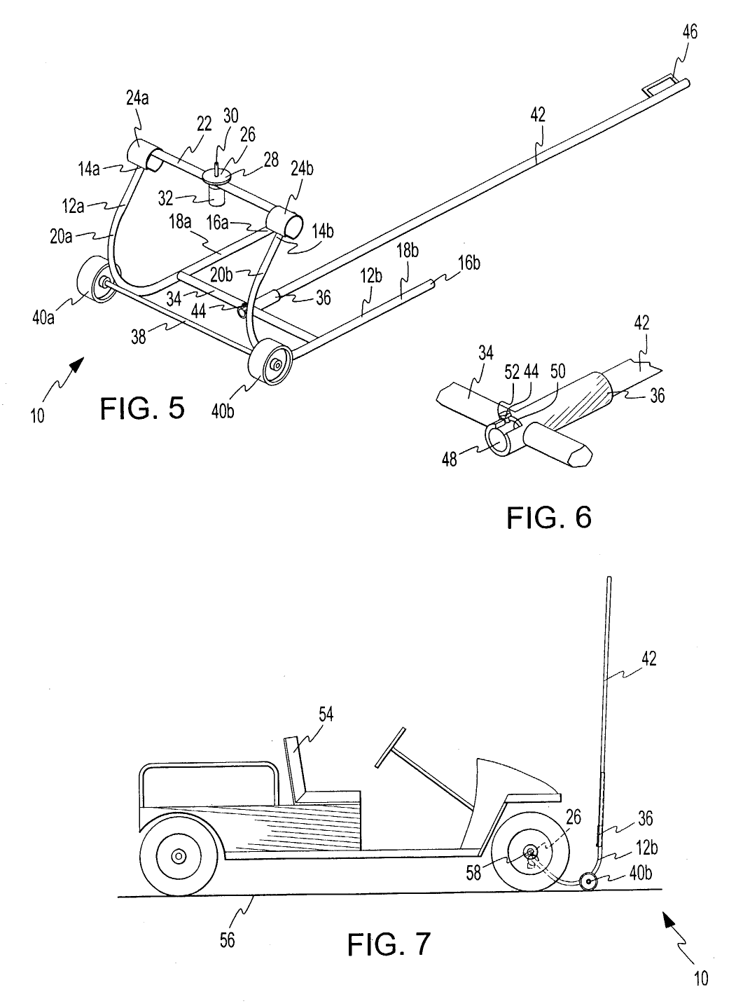

The leverage handle 42 is inserted into the bore 48 of the sleeve 36 as illustrated in FIG. 3, assuming an initial or unlocked position. As shown in detail in FIG. 4, the pin 44 substantially occupies the first notch 50 of the sleeve 36 before the leverage handle 44 is rotated and locked within the sleeve 36. Once the leverage handle 44 is rotated toward the second notch 52 as shown in FIGS. 5 and 6, the pin 44 occupies the second notch 52 and frictionally engages the surrounding edge of the sleeve 36, which assists in holding the pin 44 in the locked position. At this point, the rolling jack 10 can be moved and pivoted to lift and lower a light vehicle by grasping and manipulating the handle 46 of the leverage handle 42.

In FIG. 7, the rolling jack 10 is positioned under a light vehicle 54 (golf cart) resting upon a ground or support surface 56 so that the pin 26 (shown in phantom line) on the first cross member 22 engages a front axle 58 or similar component of the vehicle 54. The jack 10 is pivoted into an upright position so that the leverage handle 42, locked within the sleeve 36 as described earlier, is generally disposed in perpendicular relation to the ground surface 56. The wheels 40a, b support the jack 10 upon the ground or support surface 56 in such position.

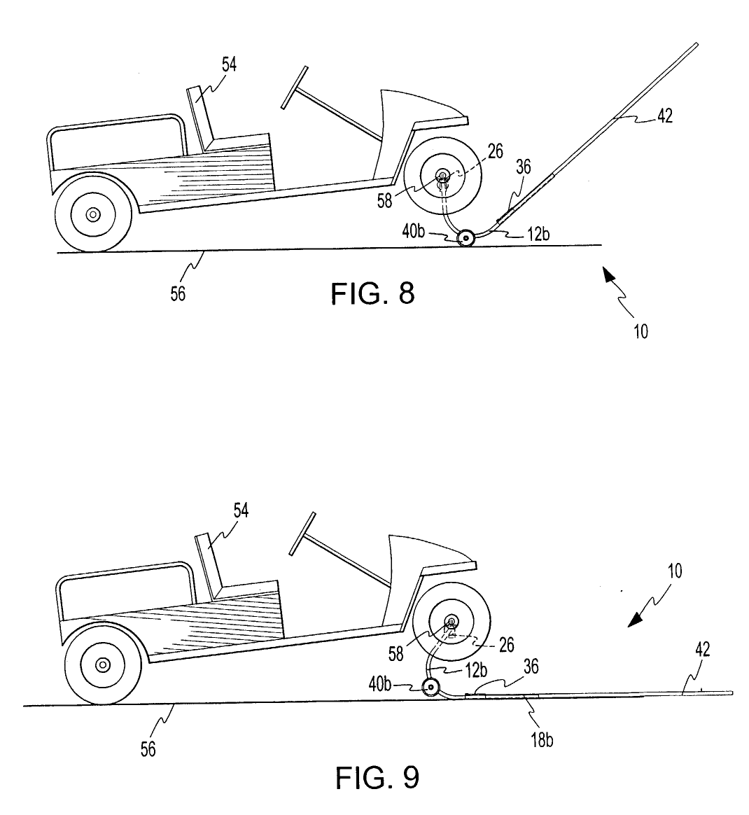

The light vehicle 54 is initially lifted above the ground or support surface as shown in FIG. 8 by pulling the leverage handle 42 away from its initial position of FIG. 7 and the light vehicle 54. As the jack 10 pivots downward toward the ground or support surface 56, the pin 26 engaging the axle 58 of the light vehicle 54 rotates with respect to the first tubular cross member 22 so that it maintains its original position with respect to the axle 58 At this point, the light vehicle 54 can be moved or wheeled to another location upon the rear wheels thereof and the wheels 40a, b of the jack 10, which is pulled, pushed, turned, or otherwise manipulated by a user grasping the leverage handle 42 If it is necessary to maintain the light vehicle 54 in a lifted position for servicing the front under side thereof, the roller jack 10 is pivoted further upon the wheels 40a, b until the straight sections 18a, b of the lateral tubular members 12a, b and leverage handle 42 make contact with ground or support surface 56 and the wheels 40a, b of the jack 10 are disposed above said ground or support surface 56 a illustrated in FIG. 9 As such, the rolling jack 10 in said configuration provides a secure, stationary support for the light vehicle 54 in the lifted position.

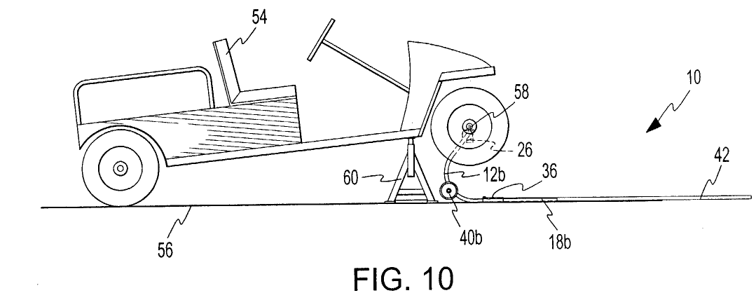

With the light vehicle 54 supported above the ground surface 56 in a stationary position as shown in FIG. 9, jack stands 60 can be inserted under said light vehicle 54 as illustrated in FIG. 10 to support said vehicle 54 upon the frame thereof in order to free up the rolling jack 10.

While this version of the invention has been illustrated and described in detail in the drawings and foregoing description, the same is to be considered as not restrictive in character, it being understood that only the preferred embodiment has been shown and described and that all changes and modifications that come within the spirit of the version of the invention are desired to be protected. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Having thus described my invention, I claim:

1. A rolling jack for lifting an end of a vehicle comprising:
a two lateral side tubular members, each tubular member having a straight section and an arcuate section, the straight section making contact with a support surface when the rolling jack is in a resting position;
each lateral side tubular member being maintained in parallel arrangement and being spaced apart from each other by a first tubular cross-member and a second tubular cross-member;
the first tubular cross-member being affixed at opposite ends thereof to unattached ends of the arcuate sections of the lateral side tubular members;
a cylindrical cap attached to each junction of the first tubular cross-member and arcuate sections of the lateral side tubular members;
a pin portion affixed in rotating engagement to a medial portion of the first tubular cross-member;
the second tubular cross-member being attached at opposite ends to the straight sections of the lateral side tubular member;
said second tubular cross-member having a sleeve attached in perpendicular arrangement to a medial portion thereof;
said sleeve having a bore with a notch end for receiving an elongated leverage handle, said bore further having a notch in an aft end;
the elongated leverage handle having a handle end and a sleeve insertion end with a pin for fitting in the notch in the sleeve;
an axle with wheels on each end, said axle being attached to a bend of
the arcuate sections of the lateral side tubular members;
said wheels being disposed some distance above the support surface when the rolling jack in the resting position so that the wheels make contact with the support surface when the rolling jack is pivoted to lift the end of the vehicle.

2. The rolling jack of claim 1 further comprising a grasping handle on the handle end of the leverage handle for inserting at least one hand of a user.

3. The rolling jack of claim 1 wherein the notch in the sleeve for the insertion of the pin on the sleeve-insertion end of the leverage handle is L-shaped so that first pulling the leverage handle towards the user causes the pin to travel along a vertical portion of the L-shaped notch until it reaches a perpendicular cut of the L-shaped notch wherein the leverage handle is rotated so that it causes the pin to become locked from sliding in the notch.

4. The rolling jack of claim 2 wherein the notch in the insertion of the pin on the sleeve-insertion end of the leverage handle is L-shaped so that first pulling the leverage handle towards the user causes the pin to travel along a vertical portion of the L-shaped notch until it reaches a perpendicular cut of the L-shaped notch wherein the leverage handle is rotated so that is causes the pin to become locked from sliding in the L-shaped notch.

5. The rolling jack of claim 1 wherein the pin portion of the medial portion of the first tubular cross-member comprises a disk affixed to the top side of the cross-member, a first cylindrical member attached in perpendicular arrangement to the disk and a second cylindrical member secured to an underside thereof.

6. A method for lifting the end of a vehicle in order to reposition said vehicle and to support said vehicle using a rolling jack comprising two lateral side tubular members, each tubular member having a straight section and an arcuate section, the straight section making contact with a support surface when the rolling jack is in a resting position;
each lateral side tubular member being maintained in parallel arrangement and being spaced apart from each other by a first tubular cross-member and a second tubular cross-member;
the first tubular cross-member being affixed at opposite ends thereof to unattached ends of the arcuate sections of the lateral side tubular members;
a cylindrical cap attached to each junction of the first tubular cross-member and arcuate sections of the lateral side tubular members;
a pin portion affixed in rotating engagement to a medial portion of the first tubular cross-member;
the second tubular cross-member being attached at opposite ends to the straight sections of the lateral side tubular member;
said second tubular cross-member having a sleeve attached in perpendicular arrangement to a medial portion thereof;
said sleeve having a bore for receiving an elongated leverage handle, said bore further having a notch in an aft end;
the elongated leverage handle having a handle end and a sleeve insertion end with a pin for fitting in the notch in the sleeve;
an axle with wheels on each end, said axle being attached to a bend of the arcuate sections of the lateral side tubular members;
said method comprising the steps of:
inserting the leverage handle into the sleeve and rotating said handle until the pin occupies the notch in the sleeve thereby locking the leverage handle within the sleeve;
manipulating the leverage handle to position the rolling jack under the vehicle in a manner that the pin portion located on the first tubular cross-member engages the end of the vehicle;
pushing downward on the leverage handle so that the rolling jack pivots upon the wheels on the axle, the rolling jack causing the end of the vehicle to be lifted;
and, transporting the vehicle to a desired location.

7. The method of claim 6 further comprising the step of:
pushing downward on the leverage handle until the leverage handle makes contact with the support surface so that the rolling jack is disposed in a stationary position with the vehicle securely supported above a support surface.
